(19) United States
(12) Patent Application Publication
(10) Pub. No.: US 2013/0167868 A1
(43) Pub. Date: Jul. 4, 2013

(54) Stem Soaker

(71) Applicant: Donald Brewer, Laconia, NH (US)

(72) Inventor: Donald Brewer, Laconia, NH (US)

(21) Appl. No.: 13/525,911

(22) Filed: Jun. 18, 2012

Related U.S. Application Data
(60) Provisional application No. 61/580,745, filed on Dec. 28, 2011.

(51) Int. Cl. A47G 23/00; B08B 1/00; B29C 65/58

(52) U.S. Cl. 134/6; 220/694; 29/453

(57) ABSTRACT

A protective device designed to absorb condensation occurring on stemmed glassware. The protective device comprises a surrounding member having an outside surface and an inside surface, where a slit element substantially transects the protective device between the outside surface and the inside surface, and a method of using the same.

### CROSS-REFERENCE

This application claims priority from Provisional Patent Application Ser. No. 61/580,745 filed Dec. 28, 2011.

### FIELD OF THE INVENTION

This invention pertains generally to an absorbent device, and more particularly to an absorbent device used to protect a user from condensation that collects on the outside surface of glassware such as a long stem wine glass and a method of using the same.

### BACKGROUND

When using long stem glassware with chilled wine or other beverages, condensation can form on the outside surface of the glass. This condensation often runs down the stemware and drips onto clothing or other surfaces. Additionally, liquid may drip down the side of the glassware as a user drinks creating an additional hazard. Water condensation can form unsightly and uncomfortable water marks on clothing, and may damage many surfaces. Condensation from other liquids, especially alcohols, may leave strong undesirable odors and/or significant stains on the clothing or other surfaces such as furniture or other resting surfaces.

Consequently, there exists a need for an absorbent protective device designed to protect users and surfaces from the condensation that may collect and run down the stem of glassware. The present invention discloses a device for preventing condensation from dripping onto clothing or other surfaces, such as a tablecloth, thereby preventing uncomfortable or unsightly water or liquid marks and a method of using the same. The device is useable with a wide variety of existing stemmed glassware, such as wineglasses, champagne flutes, and the like. Additionally, the protective device aids in identification of a particular glass when in a setting such as a party where numerous long-stem glasses are in use simultaneously.

### SUMMARY

The following presents a simplified summary in order to provide a basic understanding of some aspects of the disclosed invention. This summary is not an extensive overview, and it is not intended to identify key/critical elements or to delineate the scope thereof. Its sole purpose is to present some concepts in a simplified form as a prelude to the more detailed description that is presented later.

The subject matter disclosed and claimed herein, in one aspect thereof, comprises a protective device for use with stemmed glassware and a method of using the same. The protective device comprises a surrounding member having an outside surface and an inside surface. A slit element transects the protective device between the outside surface and the inside surface so that the protective device may substantially encapsulate a stem of the stemmed glassware. Additionally, a decorative element may aid in identification of a particular glass in settings where there are a plurality of glasses.

Furthermore, in the preferred embodiment of the invention, the protective device comprises an absorbent and flexible material permitting a first end and a second end of the slit element to be spread apart wide enough to receive the stem of the stemmed glassware. Once the encapsulating member is placed so that a portion of the inside surface is adjacent to the stem, the first end and the second end are permitted to relax thereby closing around and substantially encapsulating the stem. Once the protective device is in place around the stem, the composition of the material permits absorption of any condensate that migrates down the stem.

To the accomplishment of the foregoing and related ends, certain illustrative aspects are described herein in connection with the following description and the annexed drawings. These aspects are indicative of the various ways in which the principles disclosed herein can be practiced and all aspects and equivalents thereof are intended to be within the scope of the claimed subject matter. Other advantages and novel features will become apparent from the following detailed description when considered in conjunction with the drawings.

### BRIEF DESCRIPTION OF THE DRAWINGS

FIG. 1 illustrates a perspective view of a protective device in accordance with the disclosed architecture.

FIG. 2 illustrates a perspective view of the protective device in an open position in accordance with the disclosed architecture.

FIG. 3 illustrates a perspective view of the protective device used in conjunction with a long stemmed glass in accordance with the disclosed architecture.

FIG. 4 illustrates a plurality different designed protective devices in accordance with the disclosed architecture.

### DETAILED DESCRIPTION

Reference is now made to the drawings, wherein like reference numerals are used to refer to like elements throughout. In the following description, for purposes of explanation, numerous specific details are set forth in order to provide a thorough understanding thereof. It may be evident, however, that the novel embodiments can be practiced without these specific details. In other instances, well known structures and devices are shown in block diagram form in order to facilitate a description thereof. The intention is to cover all modifications, equivalents, and alternatives falling within the spirit and scope of the claimed subject matter.

The present invention discloses a protective device for absorbing condensation and/or other liquids occurring on an outside surface of stemmed glassware so that the condensation and/or liquids do not drip down onto a surface or a user, and a method of using the same. The protective device comprises a surrounding member having a slit element. The slit element transects the surrounding member between an outside surface and an inside surface. The protective device allows a user to spread apart the slit element so that the inside surface may be placed against a stem of a stemmed glass so that when the slit element is relaxed, the surrounding member substantially encapsulates the stem of the stemmed glass. The protective device is designed to absorb any condensation that may collect on the outside surface of the stemmed glassware and run down the stem. Additionally, a decorative element allows the protective device to be customizable or otherwise assist a user in recognizing the user's glass when in a setting where several similar glasses are in use, such as a party or other social gathering.

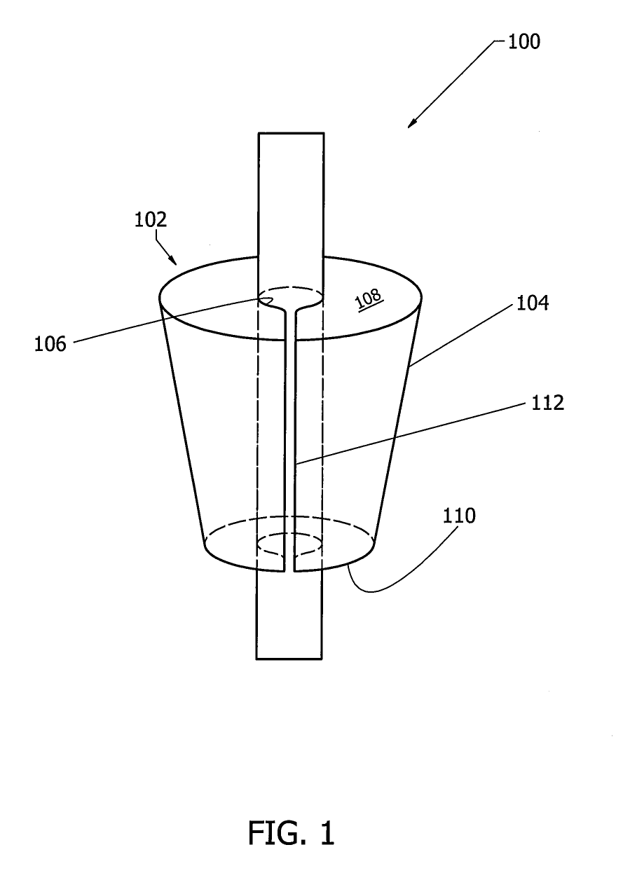

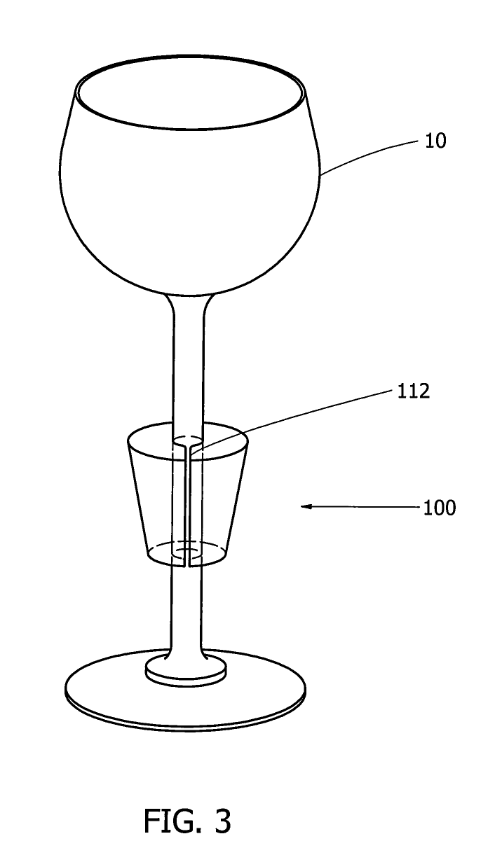

Referring initially to the drawings, FIGS. 1 and 3 illustrate a protective device 100 for use with stemmed glassware designed to substantially encapsulate at least a portion of a stem 20 of a piece of stemmed glassware 10. As illustrated in FIG. 3, the piece of stemmed glassware 10 typically comprises the stem 20, a cup portion 30, and a tapered base 40. Stemmed glassware may comprise a wine glass, a brandy sniffer, a martini glass, a champagne flute, a Manhattan glass, a margarita glass, and the like, or any other stemmed drinking vessel known in the art. Additionally, the term glassware is not meant as a limitation on the material as glassware may include materials such as plastics, crystal, glass, acrylic, and the like. For example, glassware may include a disposable plastic wine glass for use at a picnic.

The protective device 100 comprises a surrounding member 102 having an outside surface 104 and an inside surface 106. The protective device 100 is preferably constructed of an absorbent material such as sponge, however any other suitable absorbent material such as closed cell sponges, cellulose sponge, neoprene, low-density polyether, polyester, loofahs, cloth fabric, foam, and the like, as is known in the art may be used without affecting the overall scope of the invention. These materials are advantageous as they are generally absorbent, economical, and flexible.

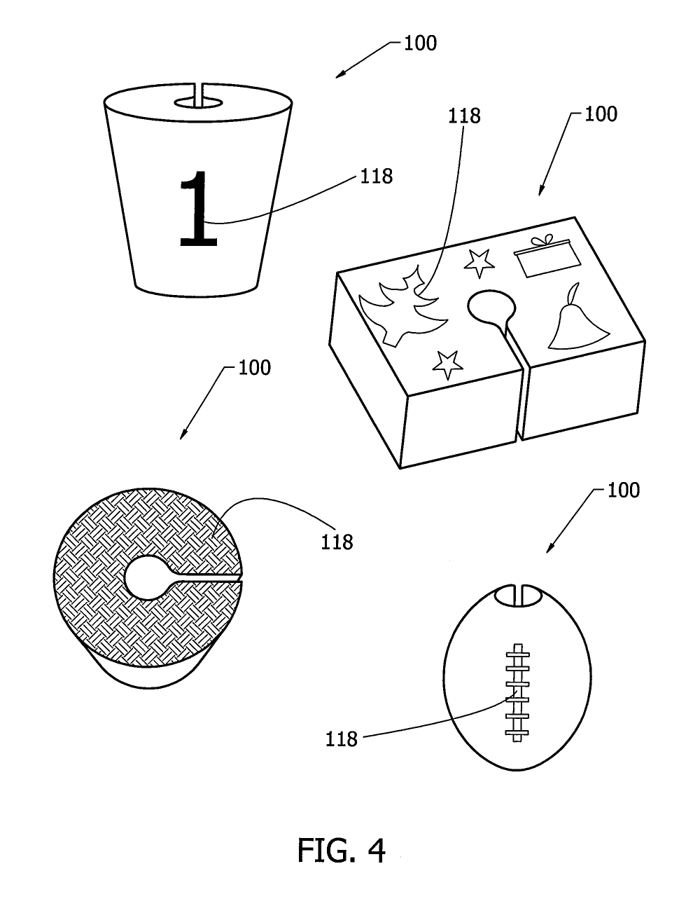

The surrounding member 102 is generally cylindrical in shape wherein the outside surface 104 and the inside surface 106 are substantially circular, however this is not meant as a limitation as any other suitable shape as is known in the art may be used. For example, the inside surface 106 may be conical or tapered in shape so as to better fit the stem 20 if the stem widens or narrows along the length. As illustrated in FIG. 4, the outside surface 104 has additional alternatives for shapes such as square, rectangular, spherical, oblong, conical, polygonal, geometric, and the like. Additionally, the outside surface 104 may include theme shapes such as but not limited to holiday themes, wedding themes, sports themes, football-shaped, ergonomic shapes, hockey puck shaped, and the like.

Returning to FIG. 1, when substantially circular in shape, the outside surface 104 typically has a diameter of approximately between ½ and 2 inches. Similarly, the inside surface 106 typically has a diameter of approximately between ¼ and ½ inches. However, the only limitation on either of the diameters is that the inside surface 106 diameter must necessarily be smaller than that of the outside surface 104 diameter. For example, if the inner surface 106 was approximately ¾^{th} inches in diameter to accommodate a wider than normal stem, the outer surface 104 would have to be more than ¾^{th} of an inch in diameter.

The surrounding member 102 further comprises a top surface 108 and a bottom surface 110. The top surface 108 and the bottom surface 110 are typically flat and generally interchangeable in orientation. In other words, the protective device 100 will still function even if placed on the stem 20 upside down. Generally, the surrounding member 102 is between approximately ¼^{th} and 1½ inches in height, however, the only upper limit on height is the length of the stem 20. While generally planar in orientation, the top surface 108 and the bottom surface 110 may also comprise different shapes such as angles, curves, ridges, and the like. For example, the top surface 110 may be substantially flat, while the bottom surface 108 is angled in shape so that the bottom surface 108 substantially abuts and conforms to the tapered base 40 of the glassware.

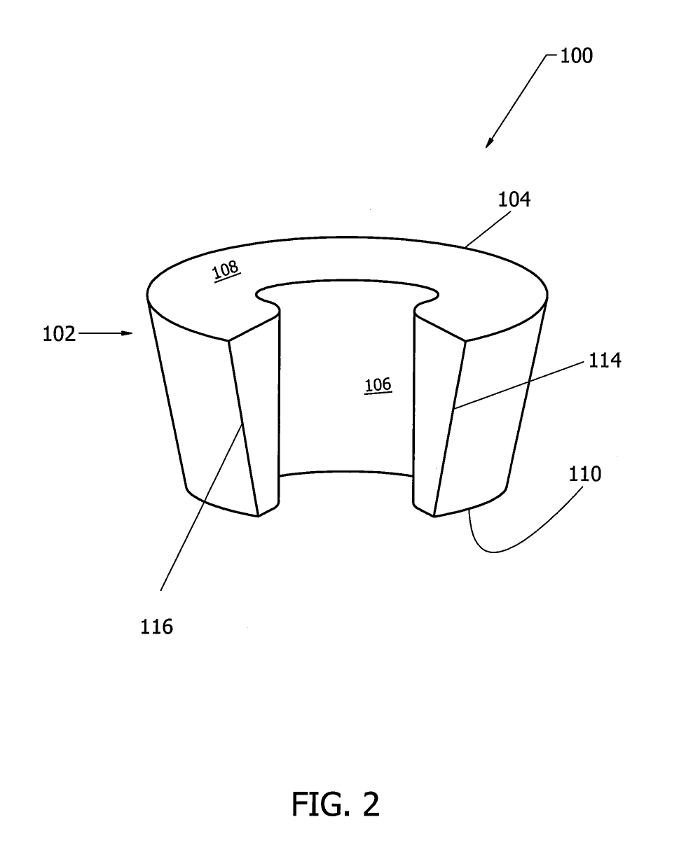

As illustrated in FIG. 2, the protective device 100 further comprises a slit element 112 having a first end 114 and a second end 116. The slit element 112 generally transects the protective device 100 between the outside surface 104 and the inside surface 106 from top to bottom. When in a closed position as seen in FIG. 1, the first end 114 and the second end 116 of the slit element 112 are substantially adjacent and parallel. To position the protective device 100 around the stem 20, the first end 114 and the second end 116 are spread open creating a gap wide enough to receive the stem 20 of the glassware as seen in FIG. 2. Once the stem 20 is within the inside surface 106, the first end 114 and the second end 116 of the slit element 112 are relaxed so that the surrounding member 102 substantially encapsulates a portion of the stem 20.

As illustrated in FIG. 4, the protective device 100 further comprises a decorative element 118. The decorative element 118 may comprise one or more elements, colors, designs, attachments, and the like alone or in combination. In one embodiment, the decorative element 118 may simply be a different color from the decorative element 118 of a second protective device (not shown). The decorative element 118 allows the user to customize the glassware with elements such as numbers, letters, words, pictures, designs, logos, advertisements, sports themes, holiday themes, insertable elements, and the like, as desired. For example, the decorative element 118 could include a unique user identifier such as a different number for each guest. For example, the user of the piece of stemmed glassware 10 having the protective device 100 with the decorative element 118 comprising the number “5” would easily be able to distinguish his glass from others during a party.

To protect the user from condensation or drips, the user will generally make use of the protective device 100 in conjunction with the piece of stemmed glassware 10. Preferably, the decorative element 118 of the selected protective device 100 will include a unique identifier as described supra, to aid in later identification. The slit element 112 is spread apart so that a gap is created between the first end 114 and the second end 116 wide enough to fit around the stem 20 of the glassware. The stem 20 is then placed within the gap and the first end 114 and the second end 116 are permitted to retract back to the closed position. At this point, at least a portion of the stem is substantially encapsulated by the protective device 100. The user may then position the protective device 100 along the length of the stem 20 as desired. For example, the protective device may be pushed toward the cup portion 30 so that the user may grasp the stem 20 at a point below the protective device 100. As condensation forms on the outside surface of the glassware, the liquid will migrate downward and be absorbed by the protective device 100. Once saturated or no longer needed, the protective device 100 is simply removed from the stem 20 and cleaned or discarded. Additionally, the protective device 100 can be reused simply by removing the protective device 100 from the stem 20, compressing the protective device 100 between a folded napkin, or the like, and replacing on the stem 20 for continued use. The user may also dampen or moisten then dry the protective device 100 by this method prior to the initial use for maximum absorption in hot, high humidity environments.

Other variations are within the spirit of the present invention. Thus, while the invention is susceptible to various modifications and alternative constructions, a certain illustrated embodiment thereof is shown in the drawings and has been described above in detail. It should be understood, however, that there is no intention to limit the invention to the specific form or forms disclosed, but on the contrary, the intention is to cover all modifications, alternative constructions, and equivalents falling within the spirit and scope of the invention, as defined in the appended claims.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. The term “connected” is to be construed as partly or wholly contained within, attached to, or joined together, even if there is something intervening. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate embodiments of the invention and does not pose a limitation on the scope of the invention unless otherwise claimed. No language in the specification should be construed as indicating any non-claimed element as essential to the practice of the invention.

Preferred embodiments of this invention are described herein. Variations of those preferred embodiments may become apparent to those of ordinary skill in the art upon reading the foregoing description. The inventor expects skilled artisans to employ such variations as appropriate, and the inventor intends for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A protective device for use with stemmed glassware, the protective device comprising:
a surrounding member having an outside surface and an inside surface;
a slit element transecting the protective device between the outside surface and the inside surface; and
a decorative element.

2. The protective device of claim 1, wherein the protective device comprises an absorbent material.

3. The protective device of claim 2, wherein the absorbent material comprises at least one of the following materials: closed cell sponge, cellulose sponge, neoprene, low-density polyether, polyester, loofah, cloth fabric, or foam.

4. The protective device of claim 1, wherein the outside surface comprises at least one of the following shapes: circular, square, geometric, spherical, oblong, football-shaped, ergonomically shaped, or conical.

5. The protective device of claim 1, wherein the surrounding member further comprises a top surface and a bottom surface.

6. The protective device of claim 5, wherein the bottom surface is angular in shape and substantially abuts a tapered base of the stemmed glassware.

7. The protective device of claim 1, wherein the outside surface and the inside surface are substantially circular.

8. The protective device of claim 7, wherein the outside surface has a diameter between ½ and 2 inches.

9. The protective device of claim 7, wherein the inside surface has a diameter of between ¼ and ½ inches.

10. A protective device for use with stemmed glassware, the protective device comprising:
a surrounding member having an outside surface and an inside surface;
a slit element transecting the protective device between the outside surface and the inside surface, wherein the slit element comprises a first end and a second end that open to receive and close to substantially encapsulate a portion of a stem of the stemmed glassware; and
a decorative element.

11. The protective device of claim 10, wherein the inside surface is conical in shape.

12. The protective device of claim 10, wherein the protective device is between ¼ and 1½ inches in height.

13. The protective device of claim 1, wherein the decorative element comprises colors, words, pictures, advertisements, logos, sports themes, holiday themes, insertable pin elements, and user identifiers.

14. The protective device of claim 1, wherein the stemmed glassware is a wine glass.

15. A method of protecting a user from liquid condensation from a stemmed glassware, the method comprising:
locating a protective device comprising a slit element configured to substantially encapsulate at least a portion of a stem of the stemmed glassware;
spreading apart the slit element to create a gap wide enough to receive the portion of the stem;
encapsulating the portion of the stem with the protective device; and
allowing the slit element to retract around the stem so that the protective device substantially encapsulates the portion of the stem.

16. The method of claim 15, wherein the stemmed glassware comprises at least one of the following: a wine glass, a brandy sniffer, a martini glass, a champagne flute, a Manhattan glass, or a margarita glass.

17. The method of claim 15, further comprising pushing the protective device up the stem toward a cup portion of the stemmed glassware so that the user may grasp the stem below the protective device.

18. The method of claim 15, further comprising allowing the protective device to absorb liquid and removing the protective device from the stem once saturated with liquid.

19. The method of claim 15, further comprising adding a decorative element to the protective device to customize the stemmed glassware.

20. The method of claim 19, wherein the decorative element comprises colors, words, pictures, advertisements, logos, sports themes, holiday themes, insertable pin elements, and user identifiers.
